(19) United States
(12) Patent Application Publication
(10) Pub. No.: US 2019/0077579 A1
(43) Pub. Date: Mar. 14, 2019

(54) Automated tamper proof fluid dispensing arrangement

(71) Applicants: Thomas Muldoon, Marblehead, MA (US); Philip J. Conway, Lynn, MA (US)

(72) Inventors: Thomas Muldoon, Marblehead, MA (US); Philip J. Conway, Lynn, MA (US)

(21) Appl. No.: 15/732,074

(22) Filed: Sep. 13, 2017

(51) Int. Cl. B65D 83/14; B67D 7/72; B65D 83/22

(52) U.S. Cl. CPC B65D 83/14; B65D 83/224; B67D 7/72

(57) ABSTRACT

A system arranged for providing controlled discharge of gaseous and fluid elements sequentially into any of a wide variety of individual fluid and gas such as for example, whipped cream dispensing units, while preventing misuse of that system, and also reporting any needs of that system for management or resupply.

### NON-PROVISIONAL PATENT APPLICATION

The present invention relates to commercial gas-charged dispensers and more particularly to a system to permit the controlled dispensing of fluid or gas such as pressurized whipped cream, and is an improvement upon our earlier Provisional Application No. 62/495,411, filed Sep. 13, 2016, which is incorporated herein by reference and is based upon Provisional Application No. 62/496,781, filed Oct. 28, 2016, also incorporated herein by reference.

### PRIOR ART DISCUSSION

Dispensing of whipped cream in commercial establishments may often involve teenage operators and those who may be less than careful about such dispensing activities, and may involve a serious nonchalance in their business practices. Notwithstanding that, such “food product” dispensers need to be carefully filled and refilled frequently particularly during summer months when there is a strong demand for their use. The typical dispenser is a single can of pressurized gas with a cream therewithin, which can is tipped upside down and the whipped cream is dispensed on a further food product or onto the liquid within a container. These devices run out of charge very readily and may be susceptible to improper use and handling.

The efficiency of a commercial establishment with utilizing some of these systems and devices requires that they have a long period of available use and are readily controlled. Such unfortunately is not the case with the existing dispensing art.

It is an object of the present invention to overcome the disadvantages of the prior art.

It is a further object of the present invention to provide a secure fluid and gas (i.e. cream, soft drinks, concentrates, or alcoholic mixes and the like) dispensing arrangement which prompts the management as to when the system needs recharging and or refilling.

It is yet a further object of the present invention to provide a fluid/gas such as cream dispensing system which is secure from tampering, yet provides its owner or operator with the simplest and most efficient process, or for very sophisticated options, for dispensing such pressurized, spoilable material such as whipped cream.

It is yet a further object of the present invention to provide a combined fluid/gas dispensing system which minimizes and or prevents misuse of the ingredients in the system, by verifying a canister-fill process when such canister is filled by a fill hose arrangement, and wherein the system may be shut down by recognition by the fill-hose arrangement of a breach or system misuse.

The present invention provides a further improvement in safety when pressurizing a whipped cream pressurized canister. The system requires that the canister is verified and approved by the inventive system. Prior art dispensers however, allow an operator to charge a canister with more than the recommended gas to potentially create a hazard to the user. The user may pressurize an empty canister or a lid without a canister to inhale the nitrous oxide gas. The prior art user may also in error pressurize dispensers with gas without a gasket to seal the dispenser, which may cause product spillage or burns.

The present system provides a further improvement comprising a notification of agitation. The prior art whipped cream dispensers do not provide such notification. Such prior art dispensers may be under pressurized, over pressurized and under or over agitated creating inconstant product.

A further object of the present invention is to provide a fluid gas dispensing system to ensure a sanitary dispenser vessel or canister is being utilized. The system will recognize and fill the particular containers or vessels when the same container returns. The system will have a feature requiring a proper cleaning cycle before authorizing reuse. The system will be able to verify batch, time, temperature and/or product user information and notify the operators of the product that should no longer be used for the specified time cycle. A cleaning cycle would be performed in the same manner as by attaching a supply fill hose to provide back pressure from the vessel to dispense sanitized solution based on the volume of the solution in the canister. This would ensure that no dispenser is used more than what the system owner or operator requires or is otherwise programmed for cleaning. This process eliminates any chances of bacteria buildup or cross-contamination of vessels/containers.

A further object of the present invention comprises improvements in the safety of operating a pressurized canister. The system is arranged, by a program to track the amount of usage of each particular canister or vessel to ensure the canister will only be utilized for its programmed life cycle. The system will provide notification to its user that the canister vessel will no longer be allowed to be used within the system and indicate a replacement canister must be used. Prior art dispensers provide only a manufacturing date on the vessel with no ability to monitor the usage of a canister to determine the life expectancy of a vessel or canister and components attached.

### BRIEF SUMMARY OF THE INVENTION

The present invention comprises a system “S” to provide the safe dispensing of fluids, particularly gases such as nitrous oxide to a (cream or liquid) filled canister dispenser. The system permits controlled setting of predetermined amounts of fluids such as liquids and/or pressurized gas to be dispensed depending upon the recognized size of the canister or the vessel into which it is to be discharged. The arrangement of the system also prevents the tampering or misuse of such nitrous oxide gases as may be otherwise permitted with prior art typical aerosol cans, disposable cream chargers or bulk cylinders.

The system “S” in a first preferred embodiment is arranged with a pressure regulator and pressure transmitters or switches and solenoid valves in conjunction with quick connect hose assemblies or fittings controlled by a control unit with a keypad, all in proper electronic communication with a power supply. The system forms “on and off” diagnostic tests to check system components prior to operation. This arrangement permits visible and audible notification of current conditions of that system, even to off-site entities.

A control panel permits the operator to customize the screen to permit the operator to use that system. The owner and operator also have the ability through this system, to monitor all features of the system such as daily, weekly and/or annual uses of inventory of the system's use and its supplied components. The controller is programmable to limit the time of available hours of use to eliminate the possibility of after-hours tampering attempts. The controller may be programmed to individual users and to certain access levels such as administration, manager and particular operators or employees through ID techniques such as card readers, retina or print readers, number codes or the like. The system is arranged to monitor the remaining inventory, to permit order replacement of gas cylinders or for electronic notification to the administration and the operators of the system. The controller also may monitor the shift consumption on a daily, weekly or monthly basis to permit control and oversight of the system and for notification of any maintenance required, or tampering attempted.

The system includes the ability to enter a code, a barcode, an RFID identifier, a serial number, an invoice number or the like, to activate a gas canister dispenser for use within the system. Such an identifier would include the canister dispenser size, the quantity of gas supplied to the specified canister dispenser. The system would configure and monitor gas inventory according to the selected gas canister dispenser and maintain inventory and gas consumption supplied to the canister dispensers, based on the various vessel sizes and volume utilized in those canister dispensers. The system is programmed to permit activation of use only if an approved gas canister dispenser is utilized. This eliminates the possibility of attaching an unknown gas canisters dispenser or unknown components. This feature also permits the system to provide asset location. It can eliminate the potential for theft of a nitrous oxide supply cylinder should it not be attached to the system within specified amount of time after the system notifies the user a replacement gas supply cylinder is required. If the supply cylinder is not attached within the specified amount of time programmed within the system, it will provide outside notification of such activity via its computer control system.

Such tampering, when identified, may include an audible alarm a visual display and/or notification to an off-site location. The system scale may preferably weighs the gas supply cylinder's discharge into the pressurizable canister dispensing vessel unit to identify when the canister dispenser vessel is full of product and to maintain control over the cylinder inventory. The scale would weigh a specific canister dispenser vessel before the system is connected and then determine the amount of gas which would have to be used for a particular size dispenser vessel. If the weight of the canister dispenser vessel unit does not match the range of weight programmed into the system, the system will not permit such arrangement to be utilized.

The connection of the hose to the vessel or canister may also facilitate determination of what, if any, quantity of fluid or gas is needed to be fed to the canister dispenser. The system is programmed to recognize the canister dispenser according to operator input, weight sensors, RFIDs, or by reading a bar code or pass code or wireless sensor tag on the dispenser vessel/canister itself. Near Field communication (NFC) and or a sensor tag may also provide information as to temperature and vessel/canister dispenser movement. If the system does not recognize the dispenser canister/vessel, it will not fill it, and the system will issue an appropriate alert. Once the system has recognized the propriety of the vessel/canister dispenser, such dispenser vessel may be filled (or not) through the connected fill hose, by the actuation by the control unit of the system's gas and fluid release valves.

Back pressure sensed by the fill hose and its connected pressure monitor communicating therewith is also a source of information to the system, as to how much fluid/gas may need to be fed to the canister dispenser. The system is thus responsive to any fluid (i.e. cream) or gas (nitrous oxide) already in the vessel or canister, either by weight of the vessel/canister dispenser on a circuit connected receiving scale or by pressure feedback by the fill hose upon connection to the receiving connector atop the vessel/canister dispenser.

The system control unit may be programmed by the operator as to particular mix preferences to be supplied to the vessel or canister dispenser. In some instances, the vessel may be a drinking glass or carafe or pitcher whose structural parameters and characteristics are programmed into the control unit to permit specific individualized mixing of fluids/gasses for individual or group consumption.

Thus, the verification of the particular vessel/canister is accomplished by the control unit of the system, and what may already be in that vessel/canister dispenser, the system completes its verification upon supplying and finishing the filling of that vessel or canister dispenser.

The fill hose from the system preferably has a solenoid in its connector which permits automatic shut off if the canister is removed from its fill location in the system. The fill hose also has an automatic shut off feature if the system senses no further back pressure to the filling process, which indicates a leak somewhere in the fill hose arrangement or an attempted misuse of the products coming out of the fill hose normally securely attached to a coupler on the top of the vessel or canister.

The system may also be arranged to permit the blending of gases to create a variation of density and texture of the mixed products. For example compressed air, nitrogen and carbon dioxide may be utilized in programmable varying quantities. A pass code is preferably entered into the programmable control unit to initiate the systems function described hereinabove.

The system “S” is shown in a preferred embodiment has a high-pressure gas feed hose which is in fluid communication with a low pressure transmitter, and with a high pressure transmitter through a central manifold. That manifold is in communication with a regulating meter which feeds a gas control supply solenoid. That gas control solenoid is normally closed. The solenoid is in electrical communication with a power distribution rail. The power distribution rail is connected to a power supply. The power supply may be charged via a removable power cord at the base of the housing. The housing has a front half and a rear half hinged together. A PLC controller unit arranged on the inside of the front portion of the housing. The controller may in preferred embodiments, have RFID sensing means, a finger print recognition means, an authorized user ID means or the like to permit/control preprogrammed access thereto and data input as to particular canister/vessel volumes, contents and identifying symbols. The control is in electrical communication through a proper circuit, with both to the high pressure transmitter and to the low pressure transmitter, as well as preferably in magnetic contact, as part of the keying system and lock arrangement. The controller or control unit, through a proper circuit, is also in electrical communication with a red stop-alarm indicator lamp, a speaker, such as an audible or status beep alarm, and a green or “ready to go” indicator lamp. The magnetic contact lock arrangement is part of the proper closed loop circuit “C” which is electrically connected to it the powered shaker device, for agitating a filled container vessel “V” during or subsequent the filling operation. The shaker device may also be paired with, consist of, or include as part of the system, a scale for weighing product and/or containment vessels before, during or after any system process.

A step for running of the system of the present invention includes an internal clock as part of the controller which is set on or off by the systems operator or owner. The internal clock is connected to the magnetic sensor as part of the keylock actuating mechanism within the security cabinet housing. That magnetic sensor may be locked or unlocked. If it is locked, it permits the system to start up. If the system “is go”, the controller verifies the electrical and gas cylinder functions as “open” and operating satisfactorily. If in fact that inquiry is satisfied, the system indicates that it is ready to operate on the control panel display unit on the front of the housing. The operator may then connect the gas hose. The control system will verify the content within the pressurizable canister dispenser. The control system will then determine the amount of gas/fluid to be dispensed according to the amount of product determined to be contained within a specific, control system-recognized canister dispenser for a particular volume.

This volume verification of a particular canister dispenser or vessel (open container etc) is based upon sensed pressure feedback matched against pre-programmed entry into the control system for the specific container/canister dispenser or vessel identified, once that canister dispenser or vessel is sensed and recognized upon placement onto the system scale or fill platform. The identification of the “canister-in-waiting” is determined by control system scanning, bar code readings therebetween and/or input such as a pass code fed to the control system by the system operator. This verification of an approved canister dispenser or vessel device will automatically provide circuit moderated controls as to whether to fill an empty container or not fill a full canister or vessel to prevent further filling thereof, waste, abuse, misuse and contamination/spillage.

Such hose connections and sensing arrangements may include RFID sensing between the component parts to properly identify and permit connections to occur, and to report to the control unit what needs to be done, such as filling vessel/canister with fluid or gas, either shutting off further dispensing of gasses and or fluids, sending an alarm signal indicating misuse or system leakage of fluids or gasses. Once properly connected, the system then may automatically begin to fill the container, according to its sensed parameters. That sensing includes determination of the whipped cream equation, a water-cleaning equation, and/or an empty container, which may indicate tampering. Upon satisfactory completion of the filling operation, the control unit indicates through the proper closed-circuit, that the container dispenser or vessel may be agitated or weighed. The system also preferably indicates that the charging is complete and that the agitation or shaking of that now filled dispenser or vessel may be stopped. The operator is then prompted by the control unit to disconnect the supply hose and the system indicates that the pressurizing whipped cream cycle has been completed successfully, the statistics of such being transferred to the memory storage in the control unit. If the above identified operations are not indicated as “a go”, the system recycles itself through the proper circuit to control unit and/or indicates that there is a system problem to alert management and/or the system operator.

The control unit preferably notes three types of conditions. One condition is that the vessel is to be filled, the next condition is that there is no flow going to the vessel to be filled, and the third condition is that there appears to be a tampering with the system which will shut the system down.

The method of operation may include further parameters indicated between the steps of the operating procedure as controlled by the control unit. Pressure within a proper charging scenario facilitates the making a charged product. A chart would indicate solid lines where the pressure rises and falls according to certain ideal functions, all within a particular range, for a particular vessel to be filled. Another similar chart would however show a dashed line wherein the pressure is represented to dip below the normal expected pressure when for example, an operator has attempted to charge an empty container or tampering with the vessel while filling canister. The system is arranged to recognize such improper pressure values and will shut off pressurized flow within milliseconds and simultaneously indicate a “tamper attempt” on its indicator lamps and will send a signal to system operators or management of such improprieties. In one preferred embodiment, a camera will be instructed by the control unit to photograph the operator and/or the dispenser or vessel for recordation purposes.

Thus, what has been shown and described is a novel arrangement for providing controlled discharge of gaseous elements into any of a wide variety of individual containers while preventing misuse of that system and reporting any needs of that system for management or resupply.

The invention thus comprises a system for the safe and controlled dispensing of pressurized liquid/gas in a regulatable fixed quantity to a dispensing unit or canister or vessel arranged on a dispensing unit support, the system comprising: a variable gas flow regulating meter for receiving a variable quantity of pressurized gas/liquid through a supply manifold from a pressurized supply container; a controlled discharge conduit for releasing gas/liquid from the variable regulating meter into a dispensing unit supported on a dispensing unit support; and a programmable control unit arranged to electronically respond to parameters inputted into the system from the dispensing canister or vessel or unit support, to properly accommodate any variously sized dispensing canister or unit on the dispensing unit support by feedback control of the variable gas flow regulating meter. The dispensing unit support may comprise a weighing scale. The dispensing unit support may comprise a dispensing unit shaker. The system preferably includes a high pressure transmitter arranged on a high pressure side of the regulating meter for sensing and sending supply parameters of the contents of a pressurized supply container connected to the supply manifold to the programmable control unit. The system preferably includes a low-pressure transmitter arranged on a low-pressure side of the regulating meter to gauge the flow of any backpressure from the controlled discharge conduit into a dispensing unit receiving the pressurized gas/liquid. The system preferably includes a normally closed solenoid in fluid communication with the regulating meter, and wherein the solenoid is controlled by the programmable control unit to ensure that no gas is allowed through the regulating meter and through the discharge conduit unless operating approval has been generated by a proper code in the programmable control unit. The proper code includes a self-diagnostic system check of all system components for functionality. The system preferably includes a reporting arrangement to diagnostically oversee and respond to any failures within the system prior to gas and liquid being attempted to be dispensed from the dispensing unit. The control unit preferably has a proper management alarm mechanism arranged therein, to send an alert to a manager if a misuse of the nitrous oxide component of the dispensing unit is detected. The control unit is preferably arranged to detect and permit only certain operators to operate the system, by a finger print reader.

The invention also comprises a system for the control and the report posting of use of nitrous oxide gas from a supply container into a whipped cream dairy product dispensing unit, comprising: a pressure regulated meter and a solenoid valve controlled pressure transmitter arrangement controlled by a programmable control unit, for channeling pressurized gas from a supply container to a dispensing unit; a series of “on and off” diagnostic tests performed by the control unit to check system components prior to dispensing operation to provide visible and audible notification of current conditions of the system, even to off-site entities; and a control panel to permit the operator to customize the screen to permit the operator to use that system. The programmable control unit is preferably programmed to limit the time of available hours of use to eliminate the possibility of after-hours tampering attempts. The control unit is preferably programmed to detect and permit only certain individual users and to utilize the system. The control unit is preferably arranged to identify and permit users of the system by a detection selected from the group comprised of: finger print readers, employee number codes, retina readers and a ground position location.

The second scale weighs gas supply cylinder content, to enable the pressurized dispensing unit canister or vessel to identify when the dispenser vessel is full of product. The system may include a shaker arrangement to shake a dispenser canister of product into which the gasses have been dispensed, and to weigh a specific dispenser canister to determine whether the system is connected and to determine the amount of gas which would have to be used for a particular size canister dispensing unit. The control unit is preferably arranged to permit the blending of nitrous oxide and carbon dioxide gases to create a variation of density and texture of mixed dairy products.

The invention also comprises a method of safely controlling and permitting limited operator operation of a system for discharging a nitrous oxide gas into a whipped cream dispenser by a programmable control unit comprising: turning on the system to power up; inquiring by the control unit, if a GPS package is installed; inquiring by the control unit if the GPS location is approved; inquire by the control unit if the security clock system is active; performing a system component self-test pass, if no logging and notifying and display error following the user prompt and power cycle to clear up; inquire by the control unit if a gas cylinder scale package is installed; inquire by the control unit if the gas cylinder scale weight is okay; inquire by the control unit through the system if the gas cylinder pressure reading is in range; and determining by the control unit if the answer is yes, then the system is ready for dispensing of a gas and dairy liquid dispensing process. The method also preferably includes displaying a security level lockout notification and send an alarm to a defined owner, and inquiring if the user level security is satisfied; inquiring if the system security inquiries are satisfied; and filling of a whipped cream dispenser canister unit if the system security inquiries are satisfied.

The invention also comprises a system for verifying the volume contents of a pressurized whipped cream known and system recognized dispensing vessel and for verifying the possible misuse or failure of the dispensing vessel, comprising: a supply-dispensing fill hose having an upstream pressure sensor in communication with a control unit and supply source, wherein the pressure sensor reads and understands the volume of content in the known and recognized dispensing vessel via the supply-dispensing fill hose; and wherein the control unit responds to the pressure sensor by shutting the filling system off when a zero backpressure is sensed by the pressure sensor.

The present system is adaptable for nitrous oxide mixtures in addition to just nitrous oxide. The systems programming and configuration may be utilized by entering or scanning a UPC code for the primary ingredient utilized in the mix. The system will configure and operate according to a specific product programmed in various quantities and volumes which are automatically detected by the system. Additional ingredients may be utilized to further configure the system through the UPC identifier. Examples of such additional ingredients are sugar, extracts, and syrups or the like. The system will function specifically based upon the primary ingredient and the additional ingredient quantities are added to the system and modify functionality based upon the combined ingredients as determined by and within the system. The system of the present invention includes a record and playback feature to allow the user to operate the system to create custom items and/or combinations for various recipes. Such permitted programming will save the operational requirements and provide such code for future use. Such system control includes its ability to completely communicate its features and operation to an outside computer or smart phone.

### BRIEF DESCRIPTION OF THE DRAWINGS

The objects and advantages of the present invention will become more apparent when viewed in conjunction with the following drawings, in which:

FIG. 1 shows a component diagram of the security arrangement of the present invention in conjunction with further apparatus;

FIG. 2 shows a view similar to FIG. 1 in a closed-up arrangement, also listing certain components of the inventive system;

FIGS. 3.0 thru 3.6 represent flow charts showing steps of the operating procedure;

FIG. 4 is a graph which represents a charging scenario; and

FIG. 5 is a graph which represents a scenario where pressure dips below normal.

### DETAILED DESCRIPTION OF THE PRESENT INVENTION

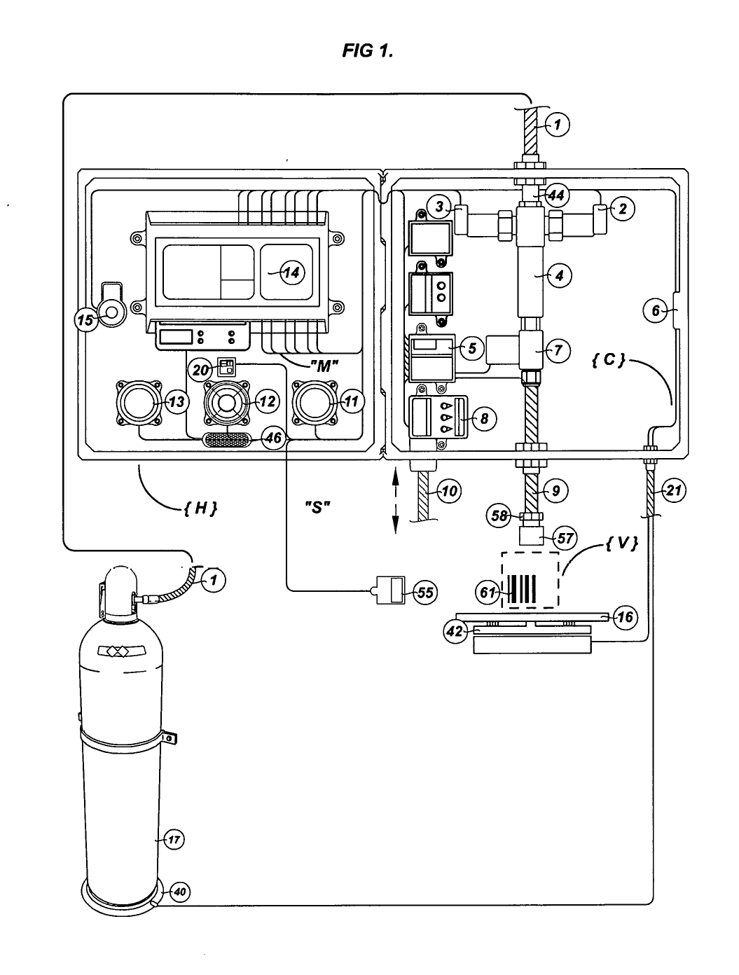

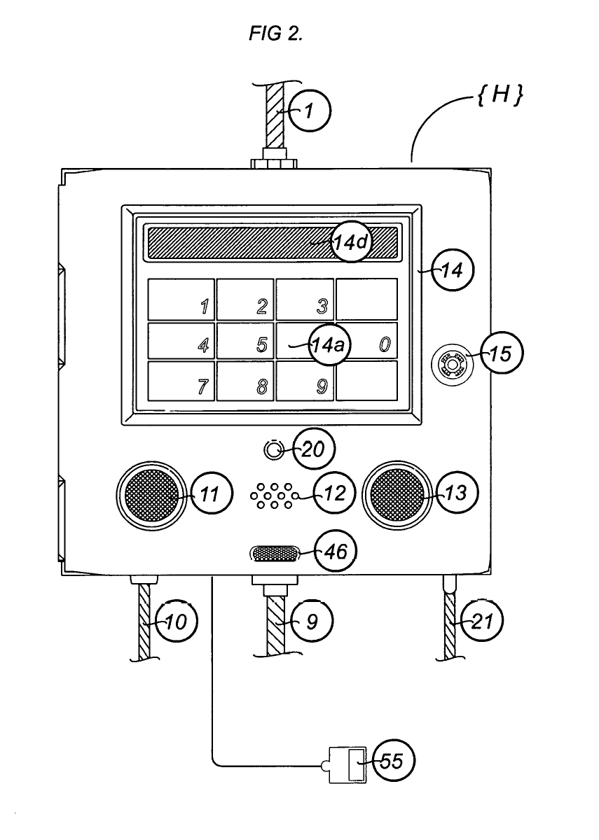

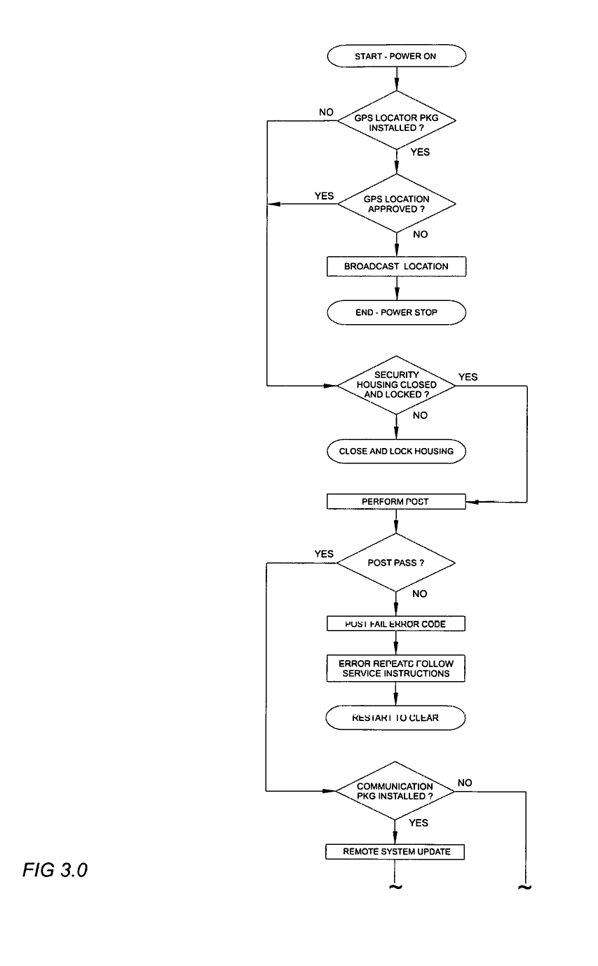

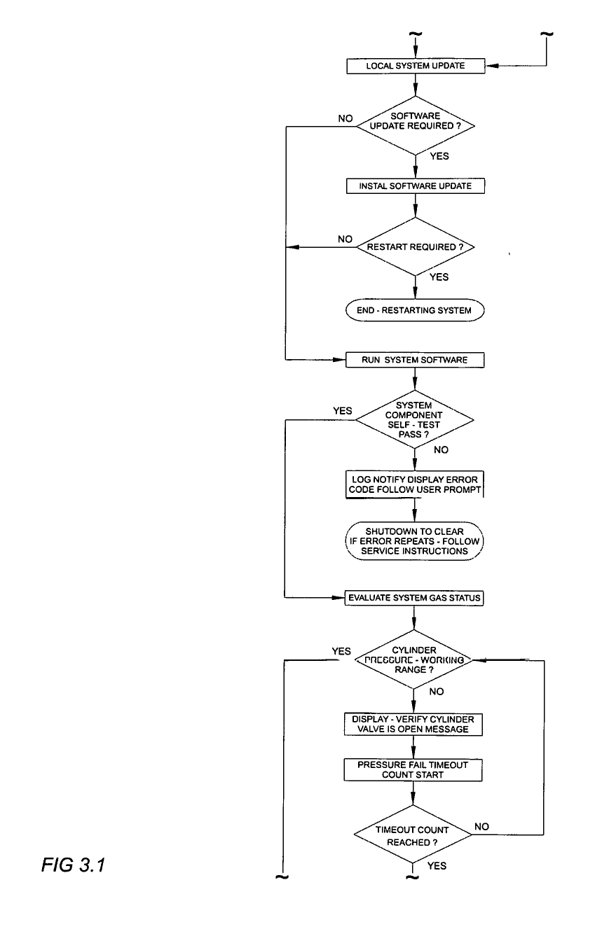

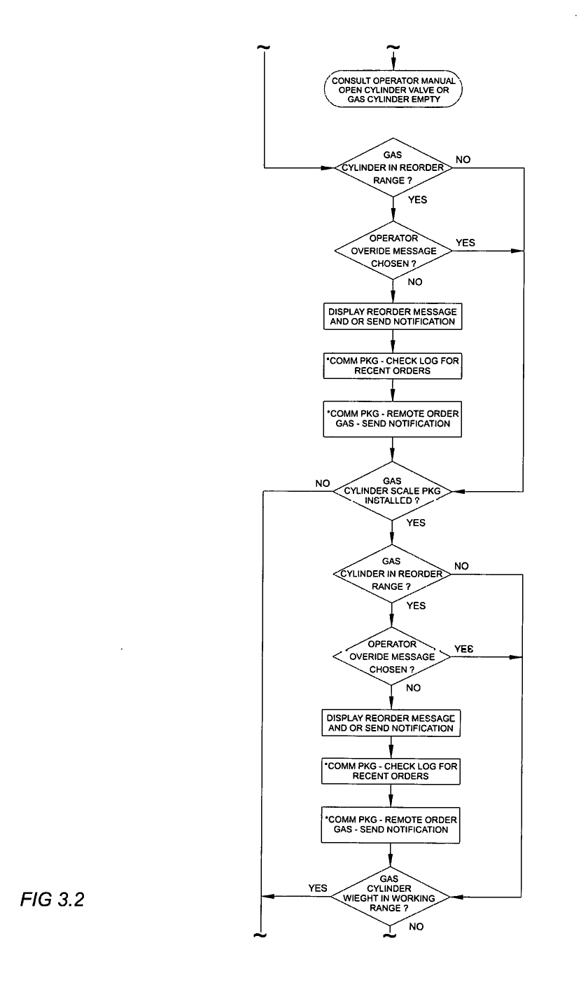

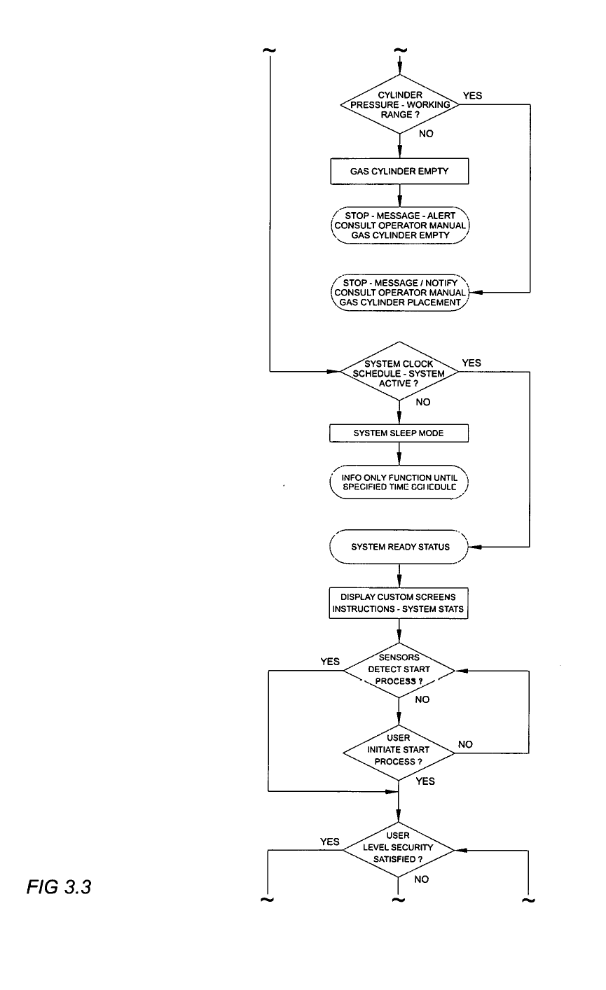

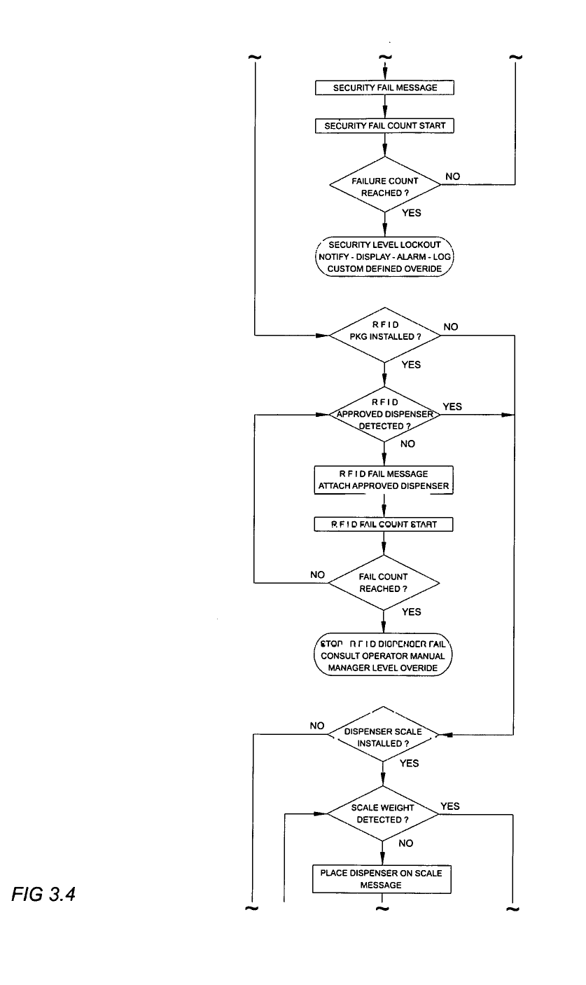

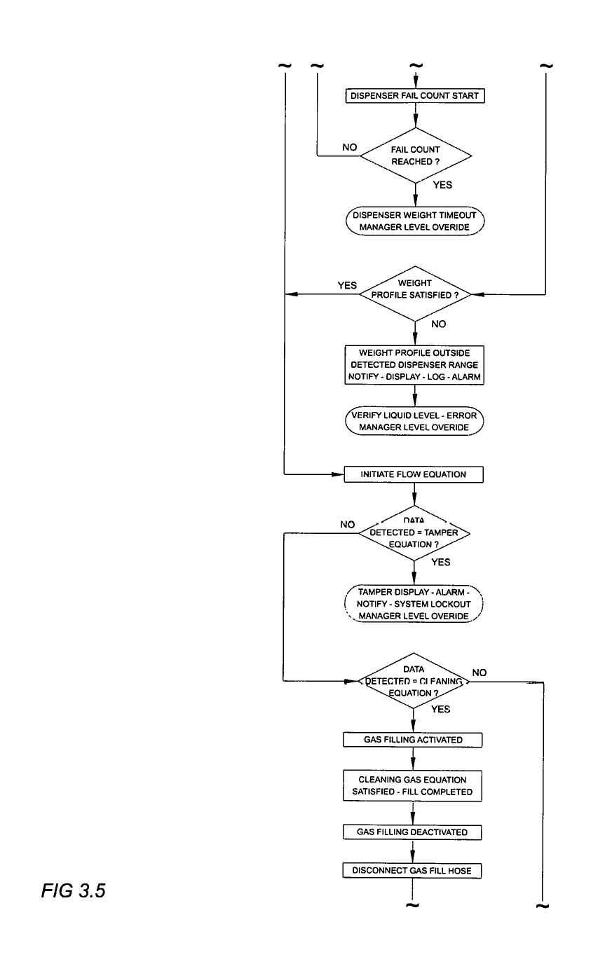

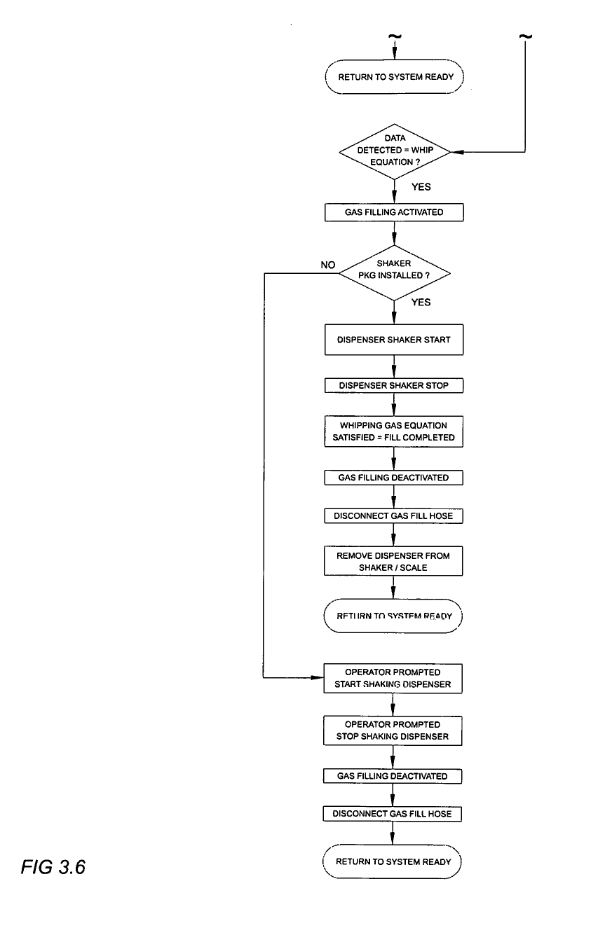

The present invention comprises a system “S” to provide the safe dispensing of potentially “miss-usable” gases such as nitrous oxide, to a canister dispenser by an operator who may, for example, have a limited interest in the cautious and safe use of such a procedure. The system “S”, as represented in FIGS. 1 and 2, and as utilized procedurally stepwise, as represented in flowchart FIGS. 3.1 through 3.8, in the earlier filed (62/495,411) Provisional Application, permits a safe, controlled setting of predetermined amounts of fluids such as for example pressurized nitrous oxide gas and/or carbon dioxide to be dispensed into a known, preprogrammed dairy product, depending upon the size of the canister or the vessel into which it is to be discharged.

The structure and procedural arrangement of the system “S” also prevents the tampering or misuse of those nitrous oxide gases as may be otherwise permitted with typical prior art aerosol cans, disposable cream chargers or bulk cylinders.

The system “S” in a first preferred embodiment is arranged with a pressure regulator and pressure transmitters or switches 2 and 3 and solenoid valves 7 in conjunction with quick connect hose assemblies or fittings controlled by an input control unit 14 with a keypad, all in proper electronic communication with a power supply 8 and cord 10, represented in FIG. 1. The system “S” forms “on and off” diagnostic tests to check system components prior to operation. This arrangement permits visible and audible notification of current conditions of that system, even to off-site entities.

The controller unit 14 with an input panel 14A permits the operator to customize the screen to permit the operator to use that system “S”. The owner and operator also have the ability through this system, to monitor all features of the system such as daily, weekly and/or annual uses of inventory of the system's use and its' supplied components. The controller 14 is programmable to limit the time of use of any or each of the particular canisters supplied to the system and the amount of available hours of use of the system to eliminate the possibility of after-hours tampering attempts. The controller 14 may be programmed to individual users and to certain access levels such as administration, manager and particular operators or employees through ID techniques such as card readers, retina or finger print readers, number codes or the like. The system “S” is arranged to monitor the remaining inventory, to permit order replacement of gas cylinders 17 or for electronic notification to the administration and the operators of the system “S”. The control unit 14 also may monitor the shift consumption on a daily, weekly or monthly basis to permit control and oversight of the system and for notification of any maintenance required, or tampering attempted. Such tampering, when identified, may include an audible alarm a visual display and/or notification to an off-site location. The system preferably also includes a scale 40 for weighing gas cylinder content, to identify when the dispenser unit vessel “V” is full of product and to maintain control over the supply cylinder inventory, as well as a shaker arrangement 42 to shake a container dispenser vessel “V” of product to which the gasses have been dispensed. A scale 16 is preferably arranged beneath a vessel “V” to provide weight of a specific dispenser or vessel “V” to determine whether the system is connected, to determine the amount of gas which would have to be used for a particular size vessel “V”. If the weight of the dispenser vessel “V” does not match the range of weight programmed into the system, the control unit 14 running the system “S” will not permit such arrangement to be utilized. Similarly, in a further embodiment, the fill hose 9, once connected to a canister or vessel “V” will provide feedback information to the control unit 14, as to the volume of fluid and gas pressure in the now identified vessel “V”, via its particular identifier 61 shown on the side of the vessel “V”, and readable by a proper optical or RFID circuit connected sensor 55.

The control panel 14 for the system “S” may be arranged to permit the blending of different fluids and or gases, to create a variation of density and texture of the mixed products, such as for example, whipped cream, soft drinks, various concentrates and or alcoholic drinks and mixers in controlled, remembered quantities and characteristics. For example, compressed air, nitrogen and carbon dioxide may be utilized in programmable varying quantities. A pass code is preferably entered into the keypad 14A of the programmable control unit 14 to initiate the systems function described hereinabove.

The system “S” is shown in a preferred embodiment thereof, in FIG. 1. A high-pressure gas feed hose 1, is in fluid communication with a first low pressure switch or transmitter 2, and a second high pressure switch or transmitter 3, through a central manifold 44. That manifold 44 is in communication with a regulating meter 4 which feeds a gas control supply solenoid 7. That gas control solenoid 7 is normally closed. The solenoid 7 is in electrical communication with the power distribution rail 5. The power distribution rail 5 is connected to a power supply 8. The power supply 8, may be charged via a removable power cord 10 shown at the base of the housing “H” in FIG. 1. The housing “H” may have a front half and a rear half hinged together, as shown in FIG. 1, and is shown in a closed configuration in FIG. 2. The PLC controller unit 14, is shown on the inside of the front portion of the housing “H” in FIG. 1, and is shown with facing toward shown forwardly in FIG. 2. The input panel 14A for the controller 14 may have a communication identifier means 46, shown in FIG. 2, such as for example, an RFID sensing means, a finger print recognition means, an authorized user ID means or the like to permit/control preprogrammed access thereto. The control unit 14 is in electrical communication through a proper circuit, with the high pressure transmitter 3 and to the low pressure transmitter 2, as well as a magnetic contact 6, as part of the keying system and lock arrangement 15, shown in FIG. 1. The control unit 14, through a proper circuit, is also in electrical communication with a red stop-alarm indicator lamp 11, a speaker, such as an audible or status beep alarm 12, and a green or “ready to go” indicator lamp 13, as shown in FIG. 2. The magnetic contact lock arrangement 6 is part of the proper closed loop circuit “C” which is electrically connected to it the powered shaker device 42, for agitating a filled container vessel “V” during or subsequent the filling operation. The shaker device 42 may also be paired with, consist of, or include as part of the system, the scale 16 for weighing product and/or containment vessels thru connector 21 and connected to circuit “C”, before, during or after any system process occurring, as represented in FIG. 1.

The flow diagram representing the methodology for the controlled running of the system “S” of the present invention is represented sequentially in FIG. 3.1 through FIG. 3.8 in the aforementioned 62/495,411 provisional application. An internal clock as part of the controller 14 is set on or off by the systems operator or owner. The internal clock is connected to the magnetic sensor as part of the key lock actuating mechanism 15 within the security cabinet housing “H”. That magnetic sensor may be locked or unlocked. If it is locked, it permits the system to start up. If the system “is go”, the controller 14 verifies the electrical and gas cylinder functions as “open” and operating satisfactorily. The system in a further embodiment includes a ground position indicator to have on/off control of the system's gas output, depending upon the appropriate/inappropriate physical location of the system. If in fact that inquiry is satisfied, the system indicates that it is ready to operate on the control panel display unit on the front of the housing. The operator may then connect the gas hose and enter the pass code into the controller 14. Such hose connections may include RFID sensing, bar code identifiers, near field communicators between the component parts to properly identify and permit connections to occur. Once properly connected, the system then may automatically begin to fill the container, according to its sensed parameters. The parameters include vessel size, vessel content, quantity of fluid content in the particular vessel, which may be sensed by operator input, data storage in the control unit 14 for the particular vessel V sensed. That sensing includes determination of the whipped cream equation, a water-cleaning equation, and/or an empty container, which may indicate tampering. Upon satisfactory completion of the filling operation, the control unit indicates through the proper closed-circuit display panel, that the container vessel thru its program, may be shaken or agitated or weighed. The system also preferably indicates that the charging is complete and that the agitation or shaking of that now filled vessel may be stopped. The operator is then prompted by the control unit 14 to disconnect the supply hose and the system indicates that the whipped cream cycle has been completed successfully, the statistics of such being transferred to the memory storage in the control unit 14. If the above identified operations are not indicated as “a go”, the system recycles itself through the proper circuit to control unit 14 and or indicates that there is a system problem to alert management and/or the system operator:

The control unit 14 through its sensor arrangement, preferably is able to note three types of conditions. One condition is that the vessel is to be filled. The next condition to evaluate is that there is no flow going to the vessel to be filled, and the third condition is that there appears to be a tampering with the system which will shut the system down. Should such a tampering be picked up/noticed by the control unit 14, a camera 20 within the control panel “H” will be signaled through a proper circuit “M” from the control unit 14, to photograph any individual near the system “S” for dealing with as necessary by the system's owners/operators. The camera 20 in other embodiments may include photographing the dispenser canister as to its propriety for use, its size and, record ingredients supplied to the dispenser canister for future reference as to user and supplies.

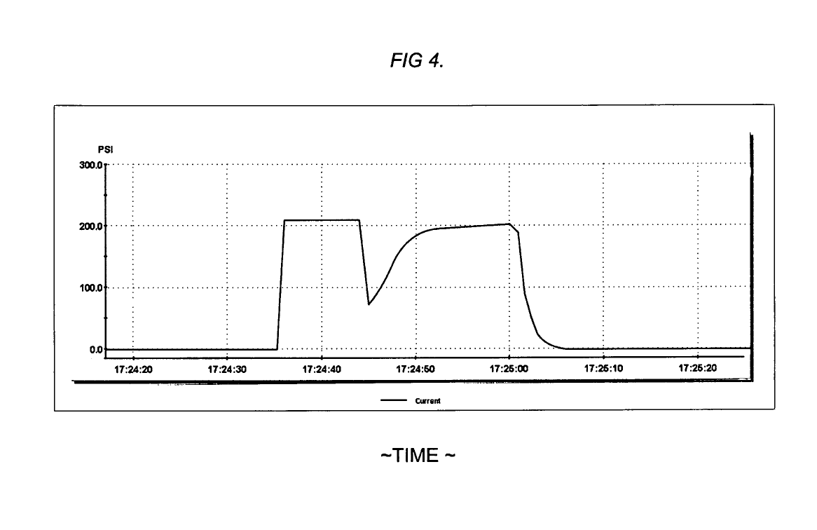

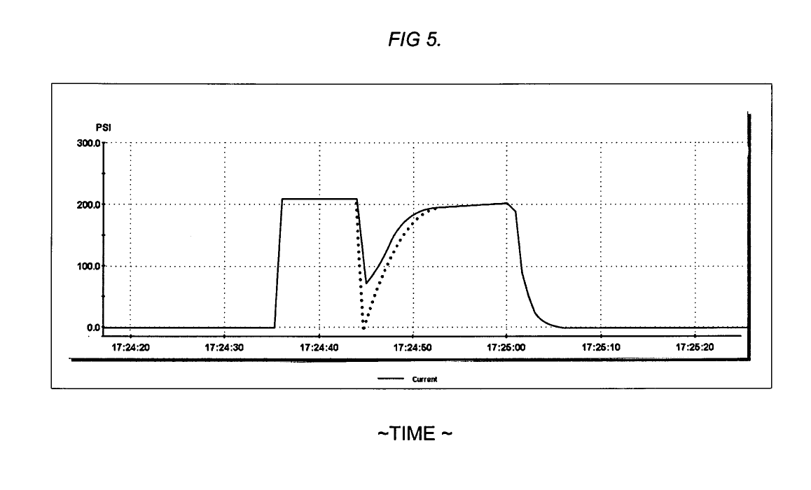

In the aforementioned '411 application, it displays FIGS. 3.0 through 3.7 which represent a flowchart with further parameters indicated between the steps of the operating procedure as controlled by the control unit 14. FIG. 4 of that '411 application represents pressure within a proper charging scenario for making a charged product. The chart indicates solid lines where the pressure rises and falls according to certain ideal functions, all within a particular range, for a particular vessel to be filled. FIG. 5 is a similar chart to FIG. 4 however showing a dashed line wherein the pressure is represented to dip below the normal expected pressure when, for example, an operator has attempted to charge an empty container. The system “S” is arranged to recognize such improper pressure values and will shut off pressurized flow within milliseconds and simultaneously indicate a “tamper attempt” on its indicator lamps and will send a signal to system operators or management of such improprieties.

The system “S” is operated by input through the input pad 14A and its associated display panel 14D, represented in FIG. 2. The method by which the system “S” insures the safety of its own ultimate use is by the controller 14 making the following properly programmed inquiries as a series of steps for checking the system components, including: properly turning on the system to power up; in the inquiring if a GPS package is installed. If the answer is yes, is the GPS location approved; if yes, is the security cabinet secured, if yes perform the posts thereof if the post is satisfied. If not, restart the system to clear errors and follow service instruction; if the post is satisfied, are there any software updates detected, if yes, install the software updates and determine if a reboot is required; if yes, install rebooting-if no, run the software; inquire if the security clock system is active, if the answer is yes, perform a system component self-test, pass-if no logging, and notify and display error following the user prompt and power cycle to clear up if there are repeats and follow service instructions; if the system component passes the self-test, inquire if the gas cylinder scale package is installed, if yes, inquire if the gas cylinder scale weight is okay; if no, inquire if gas weight in re-order is in range, if yes, display as message or remote order and log in transition and notify supplier; inquire through the system if the gas cylinder pressure reading is in range, if the answer is yes the system is ready, if the answer is no, inquire if the gas cylinder valve is open, if the gas cylinder valve is open consult the operating manual and follow troubleshooting procedure, if the gas cylinder valve is not open, open the gas cylinder valve with a message for a timeout, if the timeout count is reached, display a “pressure error” and consult operator manual for a manager level override; if the system is shown to be ready, the panel is to display the necessary message sequence for the current system information- and the user may initiate the start process; if the user start process has begun, the inquiry is made if the user level of security is satisfied, if the user level security is not satisfied a security mail message and a log-failed comment is displayed on the control panel, and a log of failure count is then reached and a security level lockout notification is displayed and an alarm/log owner is defined and continued use is overridden; if the user level security is satisfied, an inquiry by the control unit is made if the RFID or like sensor package has been installed; if the RFID or like sensor package has been installed an inquiry is made of the system as to whether the system security sensors satisfied; if the system securities sensors are satisfied, the filling by the whipped cream dispenser may be begun; once the filling process has begun an inquiry is made if the data is detected with the WHIP equation-(see FIG. 4), if the data detection WHIP equation is satisfied, the whipping process equation gas filling is activated and an inquiry is made if a shaker package has been installed within the system; if the shaker package is installed, the dispenser shaker is activated during the gas filling process, then the whipping process equation is satisfied and WHIP is completed, the gas filling is the activated, and the fill hose is disconnected, the dispenser is removed from the shaker scale 16 and the system is returned to system ready. If the shaker package was not installed, the control panel prompts the operators to start the manual shaker process, the operator is then prompted to stop the shaker process, the gas filling is then deactivated and the fill hose is instructed to be disconnected and the system is instructed to return to the system ready configuration, on the control panel 14 or the screen 14D.

There is a preferred volume verification based upon sensed pressure feedback matched against pre-programmed entry into the control system for the specific container/canister “V” identified. The identification of the “canister-in-waiting” is determined by the control system sensor/scanner 55 recognizing an identifier 61 such as for example, a UPC display on the vessel “V”, or bar code readings therebetween and/or input such as a pass code fed to the control system by the system operator. This verification of an approved canister device “V” will automatically provide circuit moderated controls as to whether to fill an empty container or not fill a full container to prevent further filling thereof, waste, abuse, misuse and contamination/spillage.

Such hose 9 and connector nozzle arrangement 57 preferably including built-in pressure feedback sensors 58 with appropriate proper feedback to the control unit 14 and communicative sensing arrangements 55 may include RFID sensing between the component hose nozzle parts 57 and 58 and canister “V” to properly identify and permit connections to occur, and to report to the control unit 14 what needs to be done, such as filling (or deny filling) vessel/canister with fluid or gas, either shutting off further dispensing of gasses and or fluids, as well as sending an alarm signal indicating too great a use history, a misuse or system leakage of fluids or gasses. Once the hose fill nozzle 57 is properly connected, the system “S” then may automatically begin to fill the approved dispenser canister “V”, according to its sensed parameters and the instructions loaded into the control unit 14 for the particular vessel/canister, its contents, and its read and understood backpressure. That sensing includes determination of the whipped cream or other fluid/gas pressure equation, a water-cleaning equation, and/or an empty container, which may indicate tampering or a leak within the supply hose 9.

Upon satisfactory completion of the filling operation, the control unit 14 indicates through the proper closed-circuit, that the container dispenser or vessel “V” may be shaken or agitated or weighed. The system also preferably indicates that the charging is complete and that the agitation or shaking of that now filled canister dispenser or vessel “V” may be stopped. The operator is then prompted by the control unit to disconnect the supply hose and the system indicates that the supply of pressure comprising the whipped cream cycle has been completed successfully, the statistics of such being transferred to memory storage in the control unit 14. If the above identified operations are not indicated as “a go”, the system recycles itself through the proper circuit to the control unit 14 and/or indicates that there is a system problem to alert management and/or the system operator.

The system thus includes a combined verification canister or vessel-fill-process by backpressure vessel-quantity-content recognition and a verification misuse-determination process also by the supply fill hose, wherein the system may be shut down by recognition by the fill-hose backpressure (zero backpressure) feedback of a system breach (leak) or system misuse.

Thus, what has been shown and described is a novel structural and procedural arrangement for providing controlled discharge of gaseous elements into any of a wide variety of individual containers while preventing misuse of that system and reporting any needs of that system for management or resupply.

1. A system for the safe and controlled dispensing of pressurized liquid/gas in a regulatable variable quantity into a whipped cream dispensing unit, the system comprising:
a variable gas flow regulating meter for receiving a variable quantity of pressurized gas/liquid through a supply line from a pressurized supply container;
a controlled discharge conduit for releasing gas/liquid from the variable regulating meter into a whipped cream dispensing unit on a dispensing unit support; and
a programmable control unit arranged to electronically respond to parameters inputted into the system from the dispensing unit, to properly accommodate any variously sized dispensing unit on the dispensing unit support by feedback control of the variable gas flow regulating meter.

2. The system as recited in claim 1, wherein the dispensing unit support comprises a weighing scale.

3. The system as recited in claim 1, wherein the dispensing unit support comprises a dispensing unit shaker.

4. The system as recited in claim 1, wherein the system includes a high pressure transmitter arranged on a high pressure side of the regulating meter for sensing and sending supply parameters of the contents of a pressurized supply container connected to the supply manifold to the programmable control unit.

5. The system as recited in claim 1, wherein the system includes a low pressure transmitter arranged on a low pressure side of the regulating meter to gauge the flow of any backpressure from the controlled discharge conduit into a dispensing unit receiving the pressurized gas/liquid.

6. The system as recited in claim 1, wherein the system includes a normally closed solenoid in fluid communication with the regulating meter, and wherein the solenoid is controlled by the programmable control unit to ensure that no gas is allowed through the regulating meter and through the discharge conduit unless operating approval has been generated by a proper code in the programmable control unit.

7. The system as recited in claim 6, wherein the proper code includes a self diagnostic system check of all system components for functionality.

8. The system as recited in claim 1, wherein the system includes a reporting arrangement to diagnostically oversee and respond to any failures within the system prior to gas and liquid being attempted to be dispensed from the dispensing unit.

9. The system as recited in claim 1, wherein the control unit has a management alarm mechanism arranged therein, to send an alert to a manager if a misuse of the nitrous oxide component of the dispensing unit is detected.

10. The system as recited in claim 1, wherein the control unit is arranged to trigger a camera within the system to photograph any individuals near the system should a misuse of that system be sensed by the control unit.

11. The system as recited in claim 1, wherein the control unit is arranged to detect and permit only certain operators to operate the system, by a finger print reader.

12. A system for the control and the report posting of use of nitrous oxide gas from a supply container into a whipped cream dairy product dispensing unit, comprising:
a pressure regulated meter and a solenoid valve controlled pressure transmitter arrangement controlled by a programmable control unit, for channeling pressurized nitrous oxide gas from a nitrous oxide supply container to a whipped cream dispensing unit;
a series of “on and off” diagnostic tests performed by the control unit to check system components prior to dispensing operation to provide visible and audible notification of current nitrous oxide conditions of the system, to off-site entities; and
a control panel to permit the operator to customize the screen to permit the operator to use that system.

13. The system as recited in claim 12, wherein the programmable control unit is programmed to limit the time of available hours of use to eliminate the possibility of after-hours tampering attempts.

14. The system as recited in claim 12, wherein the control unit is programmed to detect and permit only certain individual users and to utilize the system.

15. The system as recited in claim 12, wherein the control unit is connected to a camera so as to photograph all products utilized and any individuals near by the system for recordation purposes and also if a breach has been detected by the control unit.

16. The system as recited in claim 12, wherein the control unit is arranged to identify and permit users of the system by a detection selected from the group comprised of: finger print readers, employee number codes, retina readers and a ground position location.

17. The system as recited in claim 12, including a scale for weighing gas cylinder content, to enable the pressurized dispensing unit to identify when the dispenser is full of product and to maintain control over the cylinder inventory.

18. The system as recited in claim 12, including a shaker arrangement to shake a dispenser of product into which the gasses have been dispensed, and to weigh a specific dispenser to determine whether the system is connected and to determine the amount of gas which would have to be used for a particular size dispensing unit.

19. The system as recited in claim 12, wherein the control unit is arranged to permit the blending of nitrous oxide and compressed air gases to create a variation of density and texture of mixed dairy products.

20. A method of safely controlling and permitting limited operator operation of a system for discharging a nitrous oxide gas into a whipped cream dispenser by a programmable control unit comprising:
turning on the system to power up;
inquiring by the control unit, if a GPS package is installed;
inquiring by the control unit if the GPS location is approved;
inquire by the control unit if the security clock system is active;
performing a system component self-test pass, if no logging and notifying and display error following the user prompt and power cycle to clear up;
inquiring by the control unit if a nitrous oxide gas cylinder scale package is installed;
inquiring by the control unit if the nitrous oxide gas cylinder scale weight is okay;
inquiring by the control unit through the system if the nitrous oxide gas cylinder pressure reading is in range; and
determining by the control unit if the answer is yes, then the system is ready for dispensing of a gas and dairy liquid dispensing process.

21. The method as recited in claim 20, including:
displaying a security level lockout notification and send an alarm to a defined owner.

22. The method as recited in claim 20, including:
inquiring if the user level security is satisfied and if an RFID package has been installed;
inquiring if the system security inquiries are satisfied; and
filling of a whipped cream dispenser unit if the system security inquiries are satisfied.

23. A system for verifying the volume contents of a pressurized whipped cream known-and-system-recognized-dispensing vessel and for verifying the possible misuse or failure of the whipped cream dispensing vessel, comprising:
a supply-dispensing fill hose having an upstream pressure sensor in communication with a control unit and a nitrous oxide supply source, wherein the pressure sensor reads and understands the volume of content in the whipped cream known-and-recognized-dispensing vessel via the supply-dispensing fill hose; and
wherein the control unit responds to the pressure sensor by shutting the filling system off when a zero backpressure is sensed by the pressure sensor.

24. A system for the safe and controlled dispensing of human consumable pressurized liquid/gas in a regulatable variable quantity into a whipped cream dispensing unit, the system comprising:
a variable gas flow regulating meter for receiving a variable quantity of pressurized gas/liquid through a supply line from a pressurized supply container;
a controlled discharge conduit for releasing human consumable gas/liquid from the variable regulating meter into a whipped cream dispensing unit on a dispensing unit support; and
a programmable control unit arranged to electronically respond to parameters inputted into the system from a sensor arranged within the dispensing unit, to properly accommodate any variously sized pre-inputted dispensing unit identifiers on a dispensing unit arranged on the system's supported dispensing unit, wherein the dispensing unit support comprises a weighing scale, a dispensing unit shaker, and wherein the system includes a high pressure transmitter arranged on a high pressure side of the regulating meter for sensing and sending supply parameters of the contents of a pressurized supply container connected to the supply manifold to the programmable control unit, and wherein the system includes a low pressure transmitter arranged on a low pressure side of the regulating meter to gauge the flow of any backpressure from the controlled discharge conduit into a dispensing unit receiving the pressurized gas/liquid, and wherein the system includes a normally closed solenoid in fluid communication with the regulating meter, and wherein the solenoid is controlled by the programmable control unit to ensure that no gas is allowed through the regulating meter and through the discharge conduit unless operating approval has been generated by a proper code in the programmable control unit; and
wherein a camera is connected to the control unit to photograph any nearby individual should operating approval been obtained by the control unit.
